(19) United States
(12) Patent Application Publication
(10) Pub. No.: US 2021/0185887 A1
(43) Pub. Date: Jun. 24, 2021

(54) DETERMINATION OF UN/FAVORABLE TIME PERIODS FOR THE APPLICATION OF PLANT PROTECTION

(71) Applicant: BASF SE, Ludwigshafen am Rhein (DE)

(72) Inventors: Umit Baran Ilbasi, Sao Paulo (BR); Christoph Breitenstroeter, Leverkusen (DE); Gang Zhao, Langenfeld (DE); Peter Lancashire, Leverkusen (DE); Bjoern Kiepe, Köln (DE); Burkhard Schuetz, Leverkusen (DE)

(21) Appl. No.: 16/756,233

(22) PCT Filed: Oct. 24, 2018
(86) PCT No.: PCT/EP2018/079192

§ 371 Date: Apr. 15, 2020

(30) Foreign Application Priority Data
Oct. 26, 2017 (EP) 17198563.3
Nov. 7, 2017 (EP) 17200272.7

(51) Int. Cl. A01B 79/00; A01C 21/00; G06Q 50/02

(52) U.S. Cl. CPC A01B 79/005; G06Q 50/02; A01C 21/007; A01C 21/005

(57) ABSTRACT

The present invention relates to the application of crop protection agents with regard to side effects. The present invention provides a method, a device, a computer program product and a system that allow identification of favorable and/or unfavorable periods of time for the application of a crop protection product.

The present invention relates to the application of crop protection agents with regard to side effects. The present invention provides a method, a device, a computer program product and a system that allow identification of favorable and/or unfavorable periods of time for the application of a crop protection product.

Crop protection products are used globally to protect plants or plant products from harmful organisms or to prevent their effect, to destroy unwanted plants or plant parts, to inhibit unwanted growth of plants or to prevent such growth and/or to influence the life processes of plants in a different manner.

As well as the desirable effects mentioned, crop protection agents can also have (usually undesirable) side effects.

The side effects can be influenced by or dependent on environmental conditions. For example, weather conditions can have an influence on the degree to which side effects of a crop protection agent occur.

In this respect, there can be periods of time in which application of a crop protection agent is unviable, for example because the occurrence of side effects is to be expected owing to the conditions that exist over the period of time and the disadvantages outweigh the advantages of the crop protection agent owing to the side effects.

Information relating to side effects is typically printed on packaging of crop protection products and/or can be found in an in-pack leaflet and/or are described on a website for the product.

However, this information is usually nonspecific and does not mention all the factors that can exert an influence on the side effects. The interdependences between different factors are typically not taken into account. Moreover, a user of crop protection agents has to laboriously collate the information, but without any expectation of a conclusion specific to his wishes.

These disadvantages are remedied by the subject matter of the independent claims. Preferred embodiments can be found in the dependent claims and in the present description.

The present invention thus firstly provides a method, especially a computer-implemented method, of planning an application of a crop protection product in a field over a period of time, comprising the steps of specifying the geographic location of the field, providing agricultural information for the field, providing environmental information for the field, determining a probability of the occurrence of side effects of the crop protection product for the period of time on the basis of the agricultural information and the environmental information, generating a conclusion as to the viability of applying the crop protection product in the field over the period of time, communicating the conclusion to a user.

The present invention further provides a

device for planning an application of a crop protection product in a field over a period of time, comprising
an input unit,
a transmitting unit,
a receiving unit,
a processing unit, and
an output unit,
wherein the input unit is configured to enable a user of the device to specify the geographic location of the field and provide agricultural information for the field;
wherein the transmitting unit is configured to transmit geographic location information for the field and information as to the period of time;
wherein the receiving unit is configured to receive environmental information for the field for the period of time;
wherein the processing unit is configured to determine a probability of the occurrence of side effects of the crop protection product for the period of time on the basis of the agricultural information and the environmental information;
wherein the processing unit is configured to generate a statement as to the viability of application of the crop protection product in the field over the period of time;
wherein the output unit is configured to communicate the conclusion to the user of the device.

The present invention further provides a

computer program product comprising a data carrier on which there is stored a computer program which can be loaded into the working memory of a computer system and therein causes the computer system to execute the following steps:
ascertaining a geographic location of a field,
ascertaining agricultural information for the field,
ascertaining environmental information for the field,
determining a probability of the occurrence of side effects of a crop protection product for a period of time on the basis of the agricultural information and the environmental information,
generating a conclusion as to the viability of applying the crop protection product in the field over the period of time,
communicating the conclusion to a user.

The present invention further provides a

system comprising
an input unit configured to enable a user to specify the geographic location of a field and provide agricultural information for the field;
means of providing environmental information for the field;
a first processing unit configured to determine a probability of the occurrence of side effects of a crop protection product for a period of time on the basis of the agricultural information and the environmental information;
a second processing unit configured to generate a statement as to the viability of application of the crop protection product in the field over the period of time;
an output unit configured to communicate the conclusion to the user.

The invention is elucidated in detail hereinafter without distinguishing between the subjects of the invention (method, device, computer program product, system). Instead, the elucidations that follow are intended to be analogously applicable to all subjects of the invention, irrespective of their context (method, device, computer program product, system).

The starting point for the present invention is a person (also referred to hereinafter as user) who would like to know whether it is viable to use a crop protection product over a specified period of time in a specified field for crop plants. Alternatively, the user wants to know the period of time in which the use of a crop protection agent in the field is viable.

The term “crop protection agent” is understood to mean an agent which is used to protect plants or plant products from harmful organisms or to prevent their effect, to destroy unwanted plants or plant parts, to inhibit unwanted growth of plants or to prevent such growth and/or to influence the life processes of plants in a different manner than nutrients (for example growth regulators).

Examples of crop protection agents are herbicides, fungicides and pesticides (for example insecticides). The crop protection agent is preferably a herbicide. The crop protection agent is preferably a herbicide which becomes active on the soil of the field.

A crop protection agent usually comprises an active ingredient or a plurality of active ingredients. “Active ingredients” refer to substances that have a specific effect in an organism and cause a specific reaction. Preferably, the active ingredient is an active ingredient from the group of the diphenyl ether herbicides, most preferably aclonifen (2-chloro-6-nitro-3-phenoxyaniline).

A crop protection agent usually comprises a carrier for diluting the one or more active ingredients. Additives such as preservatives, buffers, dyes and the like are also conceivable. A crop protection agent may be solid, liquid or gaseous.

A crop protection agent is typically supplied in packaged form with information relating to use as crop protection product. A crop protection product may comprise one or more crop protection agents as a mixture or as separate components. In a crop protection product, a crop protection agent may be mixed with further substances, for example with nutrients. The crop protection product is preferably Mateno® or another aclonifen-comprising crop protection product.

In a first step of the method of the invention, the task is to specify a region of the Earth's surface in which a crop protection product is to be used.

A crop protection product is typically employed in a field in which crop plants are being grown or are to be grown.

The term “field” is understood to mean a spatially delimitable region of the Earth's surface which is preferably used for agriculture by planting crop plants in such a field, supplying them with nutrients and harvesting them.

The term “crop plant” is understood to mean a plant that is purposely grown as a useful or ornamental plant through human intervention.

Irrespective of whether the region of the Earth's surface in question in which a crop protection product is to be used is being used agriculturally or not, this region is referred to in the present context as “field”.

For specification of the field, knowledge of the geographic coordinates of at least one point within the field or on its boundaries or at least knowledge of a location close to the field is required.

The field is typically specified by a user. This user can input the geographic coordinates of at least one point in the field into the device of the invention, for example using an input unit (e.g. keyboard). It is also conceivable that a geographic map of the Earth's surface or parts thereof is displayed to the user by means of a screen. It is conceivable that the user can select a point on the map, for example with an input unit such as a computer mouse or by finger or an input pen by means of a touch-sensitive screen. It is also conceivable that the device of the invention has a position determination sensor (e.g. GPS sensor) and a user can use the location of the device to specify the field. The global positioning system (GPS), officially NAVSTAR GPS, is an example of a global navigation satellite system for determination of position. It is also conceivable that a user draws field boundaries on a digital map and hence specifies the field. It is also conceivable that the user inputs the name of a location or a region that is close to the field or includes the field into a computer system. The specification of the field ultimately serves to ascertain the geographic location of a site for which environmental conditions are to be ascertained.

In a further step of the method of the invention, agricultural information for the field is ascertained. This information is typically input into the device of the invention or the system of the invention by a user via an input unit, for example. But it is also conceivable that the information or some of the information is transferred from a database.

The term agricultural information as used in the context of the invention additionally includes the setting of the agricultural machine with which the field is being worked. This information can be provided to the agricultural machine either manually or automatically via the electronic equipment. For example, the electronic equipment of the agricultural machine can record a working step, a working sequence and/or a setting of the agricultural machine such as the seed laying depth and transmit it, for instance, to a computer or a computer system. Alternatively or additionally, a setting of the agricultural machine such as the seed laying depth can be determined with the aid of an image of parts of the agricultural machine.

The agricultural information is preferably one or more pieces of information from the following list:
crop plant which is being or is to be grown in the field,
date of sowing or planting,
state of development of the crop plant being grown (for example in the form of the BBCH code),
plant depth/seed laying depth.

The BBCH code (or else BBCH scale) gives information about the morphological stage of development of a plant. The abbreviation stands for the “Biologische Bundesanstalt, Bundessortenamt and CHemische Industrie” [Federal Biological Institute, Federal Plant Variety Office and Chemical Industry]. The BBCH scale is used in scientific communication in respect of the questions of plant development and the optimal or recommended juncture of use of fertilization and crop protection measures in the growing of useful plants.

The crop plant which is being grown or is to be grown in the field can be specified by the user. It is conceivable that the device of the invention and the computer program product of the invention are configured solely for a defined (given) crop plant. Preferably, the device of the invention and the computer program product of the invention are configured for multiple crop plants. In a preferred embodiment, a user selects the crop plant being grown or to be grown by inputting it in text form, for example, via an input unit or selecting it from a (virtual) list (e.g. pull-down menu).

Preferably, the crop plant is a cereal, even more preferably winter wheat or winter barley.

As well as the field and the crop plant being grown, the crop protection product which is to be used must also be specified. It is conceivable that the device of the invention and the computer program product of the invention are configured solely for a defined (given) crop protection product. Preferably, the device of the invention and the computer program product of the invention are configured for the use of multiple crop protection products. In a preferred embodiment, a user selects the crop protection product being used by inputting it in text form, for example, via an input unit or selecting it from a (virtual) list (e.g. pull-down menu).

It is also conceivable that the crop protection product is specified via the reading-in of an optical code. It is conceivable, for example, that an optical code is printed on a package of the crop protection product, which is read out with a suitable reading device and then the data read out are transmitted to the device of the invention or the system of the invention. Examples of optical codes are a barcode (e.g. Codabar, Code128 inter alia), a 2D code (e.g. Codablock, Code 49 inter alia) or a matrix code (e.g. DataMatrix, MaxiCode, Aztec code, QR code, inter alia).

The reading-in can be effected, for example, with an optical scanner or a camera (which nowadays is part of any smartphone).

It is of course also conceivable that information relating to the crop protection product is stored in another form, for example in an RFID tag.

Preferably, as well as the crop protection product being used, a planned dosage rate [g/L] and/or the application rate is also specified.

It is further conceivable that the user also specifies one or more periods of time for which he would like to obtain information as to whether the use of the crop protection product specified is viable or not. He could enter the period of time, for example, in a digital calendar. But it is also conceivable that there are preliminary settings stored in the computer program of the invention, for example the coming days and/or weeks. The user preferably defines the period(s) of time in which he is interested.

The term “period of time” defines a period of time, preferably in the future, for which the use of a crop protection agent is planned. Typically, the period of time is specified by naming the particular date (a defined day). But it is also conceivable that several days or one hour or several hours or one minute or several minutes or another unit is/are named for specification of the period of time.

In a next step of the method of the invention, environmental conditions for the field specified are ascertained for one or more specified periods of time.

Preferred environmental conditions are the weather over the period of time for which the use of the crop protection product is planned and the weather for one or more days (e.g. 1, 2, 3, 4, 5, 6, 7, 8, 9, or 10 days) before this period and the weather for one or more days (e.g. 1, 2, 3, 4, 5, 6, 7, 8, 9, or 10 days) after this period. Parameters that characterize the weather for a defined period of time include: maximum temperature (soil, air), minimum temperature (soil, air), average temperature (arithmetic average; soil, air), temperature variance (soil, air), air humidity (relative, absolute), (cumulated) precipitation, air pressure, wind speed, wind direction, amount of radiation (watts/square meter) for defined spectral regions, global radiation, soil moisture content.

The data of the weather conditions for one or more specified periods of time can be requested, for example, from commercial suppliers and/or from public sources. The request is preferably made at least partly via the Internet.

In a working example, at least some of the data for the environmental conditions preferably come from a weather station which, further preferably, is disposed directly in the field specified. The more exactly the environmental conditions can be measured, the more meaningful the conclusion with regard to the viability of application of the crop protection product in the field over the period of time.

Further environmental conditions that can be ascertained are, for example, information relating to the soil in the field in question: physical properties of the soil (e.g. granularity, microstructure, pore volume, effective storage density, etc.), chemical properties of the soil (carbonate content, pH, buffer range, ion exchange capacity, redox potential, etc.), biological properties of the soil (root penetration, humus content, etc.) and/or others.

It is conceivable that environmental conditions for the field in question or for the region in which the field in question is present are stored in databases that can be accessed, for example, via the Internet. It is also conceivable that environmental conditions are input by a user and/or locally ascertained and detected with the aid of sensors.

Preferably, relevant environmental conditions and relevant agricultural information are ascertained empirically beforehand. It is conceivable, for example, that the parameters which influence the side effects of a crop protection product and what kind of influence this is are ascertained in test series. In that case, the parameters requested are preferably those that exert a significant influence, and with the aid of which a cogent forecast as to the occurrence of side effects in the future is possible.

In a further step, the agricultural information and environmental information are used in order to make a forecast as to the probability with which side effects will occur for one or more specified periods of time and to what extent they may occur.

For such a forecast, it is possible to use prediction models that have been developed from test series, for example.

In a further step, the forecast side effects are assessed. The purpose of the assessment is to be able to give the user a recommendation for action: whether he should or should not use a crop protection product in question in a specified field within a specified period of time.

For this purpose, the disadvantages that arise from the side effects should be compared with the advantages offered by the crop protection product. It is conceivable, for example, to undertake an economic assessment. This is to be elucidated by an example. It is conceivable, for example, that the crop protection product is a herbicide. The use of the herbicide suppresses weeds in the field, and more resources (for example nutrients, water, sunlight) are available for the crop plant being grown. The result is an increase in yield. It is conceivable that the herbicide (also) has phytotoxic properties for the crop plant under particular environmental conditions. These phytotoxic properties lead to a decrease in yield. In an economic assessment, it is possible to ascertain whether, in spite of the side effects, there is an increase in yield and whether the costs of using the crop protection agent are lower than the gain resulting from the increase in yield. If it is worthwhile to use the crop protection agent, the use would be economically viable. If it is not worthwhile to use the crop protection agent, the use would not be economically viable.

As well as or instead of an economic assessment, an ecological assessment can also be effected.

It is also conceivable that a risk assessment is conducted on the basis of the probability of occurrence of side effects. If the probability of occurrence of side effects is at or above a defined threshold, use of the crop protection agent in the field for the period of time is advised against; if the probability is below the threshold, use is recommended. As well as such a “binary” decision logic, it is also possible to generate graded recommendations (for example in the form of a traffic-light representation (red: not recommended, yellow: conditional recommendation, green: recommendation), or in the form of other representations with even more grades).

The result of the assessment described is a conclusion as to viability. This conclusion is communicated to the user. A message is conceivable on a screen and/or via loudspeaker. The conclusion can be given in text form, in the form of symbols or colors and/or by means of speech output. The sending of an email or a message with the conclusion to the user is also conceivable.

In a further, optional step, the user uses the crop protection product within a recommended period of time. The application by the agricultural machine can be triggered in the event of a positive assessment or, if use is recommended, directly. For this purpose, it is possible to generate a trigger signal that can be transmitted to the agricultural machine. Alternatively or additionally, the trigger signal can be generated by a user confirmation independently of the assessment. Further alternatively or additionally, the trigger signal can be generated by a user confirmation in the case of predetermined assessments. For instance, on a three-stage or multistage scale, in a first and second assessment stage corresponding to a recommended application, the trigger signal can be generated by a user confirmation, whereas, at a third or higher assessment stage corresponding to no recommendation of application, the trigger signal cannot be generated by a user confirmation or is blocked.

The method of the invention is preferably at least partly assisted by one or more computers, meaning that one or more steps of the method of the invention are executed by one computer or multiple computers. In one working example, the method is advantageously executed on a distributed system. In a further working example, the method is advantageously executed as embedded software.

In a preferred embodiment, a first computer is in the user's work environment. The first computer may, for example, be a workplace computer (personal computer, PC for short) which is utilized for screen work. It may also be a mobile device such as a tablet computer, a smartphone, a laptop, a smartwatch or the like.

The first computer has an input unit configured to enable a user to specify the geographic location of a field and provide agricultural information for the field. The inputs relating to the geographic location of the field and the agricultural information, as already described, are typically made via computer mouse, keyboard and/or a touch-sensitive screen. Speech input by means of microphone and speech recognition is also conceivable. A GPS sensor for detection of the geographic position of the user has also already been described above.

The system of the invention further has means of providing environmental information for the field. Provision of the environmental information requires knowledge of the geographic location of the field. The corresponding environmental information may be stored, for example, in a database. The database may be part of the first computer, but it may also be part of a second computer to which the first computer can connect via a network (e.g. the Internet). It is also conceivable that the environmental information is ascertained, e.g. calculated, only on demand (by the first computer). Particularly for future weather conditions, it may be the case that these are only ascertained on the basis of existing weather models for the geographic location of the field and a specified period of time.

In one embodiment, there are a first computer and a second computer that can connect to one another via a network. The first computer has a receiving unit with which it can transmit information relating to the geographic location of the field (and optionally further information, for example the period of time specified) to the second computer. The second computer has a receiving unit with which it can receive the data transmitted by the first computer. The second computer ascertains environmental information for the field specified and for the period of time specified on the basis of the data received. It is conceivable that this information has already been stored on the second computer, or that the second computer calculates this information itself, or that the second computer makes contact with one or more further computers in order to procure this information. The second computer also has a transmitting unit with which it can transmit the environmental information, for example, to the first computer. The first computer also has a receiving unit with which it can receive the environmental information, for example, from the first computer. On the basis of the environmental information and the agricultural information for the field specified, a probability of the occurrence of side effects of the crop protection product is determined for the specified period of time. This is effected with the aid of a (first) processing unit. This (first) processing unit may be part of the first computer, or it may be part of the second computer. It is also conceivable that it is part of a further computer that can connect to the first computer and/or to the second computer via a network (e.g. the Internet). The processing unit supplies the agricultural information and the environmental information to a model for forecasting the side effects. The model may be dynamically process-based or else entirely or partly rule-based or statistical or data-assisted/empirical. The model has been developed beforehand, preferably on the basis of empirical determinations (e.g. field and/or laboratory trials).

In a preferred embodiment, the model for forecasting the side effects is a classification model. It is possible to use various classification models, for example neural networks, deep learning models, decision trees, random forest models, SVN, gradient boosting, naive Bayes, nearest neighbor models and the like. A preferred embodiment involves a random forest model.

Using the agricultural information and/or the environmental information, the processing unit, with the aid of the model, calculates a probability of the occurrence and severity of side effects.

Accordingly, the agricultural information and/or the environmental information preferably serve as input data for the classification model. The input data used are preferably additionally trial data or laboratory data. Preference is given to selecting more than 100 input data in order to obtain sufficiently meaningful classification models. For example, predominantly weather data are used as input data. In a further working example, more than 50, preferably more than 150, further preferably more than 500, input data are selected.

In one working example, the output data from the classification models are preferably divided into exactly four or at least four output classes, the four output classes being defined by “no damage”, “acceptable damage”, “unacceptable damage” and “severe damage”.

The definition of “no damage” corresponds here to a phytotoxicity of 0-5%, the definition of “acceptable damage” to a phytotoxicity of 5-15%, the definition of “unacceptable damage” to a phytotoxicity of 15-30%, and the definition of “severe damage” to a phytotoxicity of >30%.

The phytotoxicity indicates the degree of harmfulness of the crop protection agent to the useful plant.

In one working example, preferably based on all input data, various classification models are generated and then the forecast accuracy of the individual classification models is determined.

The individual classification models are preferably tested with different train ratios. In classification models, it has been found to be advantageous not to use all input data for training of the classification models. Instead, some of the input data should be used for a realistic test, or validation, of the results from the classification models. The training ratio indicates the proportion of the input data used for training of the classification model. Preferably, the ratio of the input data for training to the input data for testing is 0.5 to 0.8. Thus, at a training ratio of 0.8, 80% of all input data are used for training and 20% of all input data for testing of the classification model.

In one working example, preference is given to subsequently generating what is called a correlation matrix of all input variables. The correlation matrix can be used to determine a rank correlation coefficient for each input variable. The higher the rank correlation coefficient of an input variable, the better the suitability of the input variable for leading to a result of maximal accuracy in the classification model. Preferably, the rank correlation coefficient is a Spearman's rank correlation coefficient.

In one working example, preferably based on the correlation matrix, a dimension reduction is conducted, with continued use of only a reduced number of the most important input variables of the multitude of input variables. Preferably, the number of the most important input variables is below 20; in one working example, the number of the most important input variables is below 100, preferably below 50, further preferably below 10.

In one working example, all classification models are preferably subsequently generated with the reduced number of input variables and the forecast accuracy is ascertained. More particularly, as in the case of performance with all input variables, the training ratio is varied.

Subsequently, the classification model with the best forecast accuracy is selected. In one working example, the classification model with the best forecast accuracy is preferably the random forest model.

In one working example, the selected classification model with the best forecast accuracy is preferably subsequently generated with a further-reduced number of input variables and the forecast accuracies are ascertained. The further-reduced number of input variables may be reduced, for example, down to just two input variables.

Finally, the number of input variables with which the best forecast accuracy is established is selected. Alternatively, what is selected is not the number of input variables with which the best forecast accuracy is established, but rather the smallest number of input variables with which the forecast accuracy is negligibly below the best forecast accuracy.

In one working example, the most important input variables preferably include at least one or more than one of the following input variables: the type of plant, the dosage of the crop protection agent, the average soil temperature, the cation exchange capacity, the cumulated precipitation, the minimum soil temperature, the plant depth, the clay content, the maximum air temperature and the longwave radiation.

On the basis of the calculated probability, a conclusion is generated as to the viability of applying the crop protection product in the field in the specified period of time. The conclusion is generated by means of a (second) processing unit. This (second) processing unit may be part of the first computer, or it may be part of the second computer. It is also conceivable that it is part of a further computer that can connect to the first computer and/or to the second computer via a network (e.g. the Internet). The first and second processing unit may be identical or different.

If the conclusion has been generated on the second (or a further) computer, it is transmitted via the transmitting unit to the first computer that receives it by means of the receiving unit.

The first computer has an output unit with which the conclusion is communicated to the user. The output unit may be a screen and/or a loudspeaker or the like. The conclusion is preferably given via a traffic light system, with expected acceptable damage given in shades of green and expected unacceptable damage in shades of red.

In one working example, the conclusion is preferably processed further by calculating an expected yield of the field under various conditions and comparing the results with one another and evaluating them.

In one working example, the yield of the field with immediate use of the crop protection product is preferably compared with the yield of the field with later use of the crop protection product. For this purpose, the method is conducted not just under the existing conditions but likewise with forecasting of future conditions. For instance, the weather conditions and/or the price of the useful plant on the market are preferably predicted.

In one working example, the yield of the field with use of the crop protection product is preferably compared with the yield without use of the crop protection product.

On that basis, recommendations for the user as to the correct use of the crop protection product can be calculated. The return of investment is preferably calculated additionally. The recommendation to the user preferably includes a balance between phytotoxic effects and/or the yield of the field and/or the return of investment.

The embodiments described above are interchangeable with the entire teaching and the further embodiments of the present disclosure.

The computer program product of the invention can be supplied for purchasing on a data carrier and/or made available on a website via a network (e.g. the Internet) for downloading and installing.

The invention is elucidated in detail hereinafter with reference to examples and figures without wishing to restrict the invention to the examples or the features shown in the figures.

The figures show:

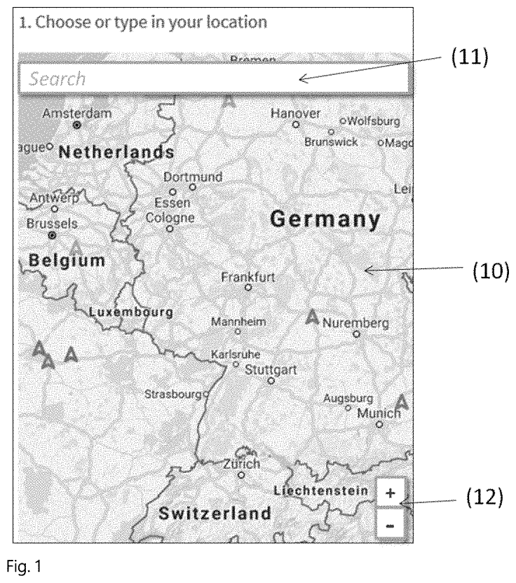

FIG. 1 shows, by way of example, part of a graphic user interface of the computer program product of the invention. The user is requested to specify the field (Choose or type in your location). A digital map (10) is displayed. In the section of map, it is possible to zoom in (+) or out (−) using the virtual buttons (12). In addition, it is possible to move the section of map using a computer mouse or a finger via a touch-sensitive screen. The field is specified either by input of a name of a location (where the field is or which is close to the field) and/or by clicking a point on the digital map (with the aid of the computer mouse or by finger).

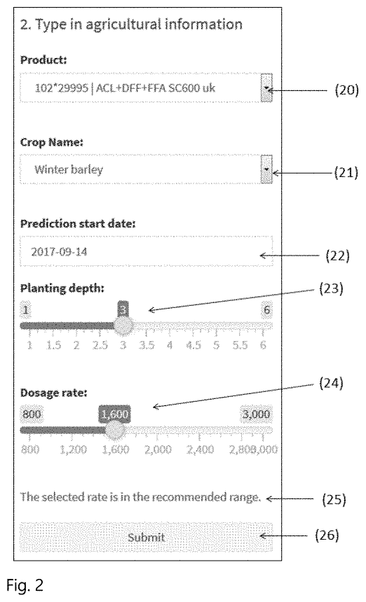

FIG. 2 shows, by way of example, a further part of a graphic user interface of the computer program product of the invention. The user is requested to provide agricultural information for the field (Type in agricultural information). The crop protection product (Product) that is to be used is selected via a virtual menu (20). The crop plant being grown in the field (Crop Name) is selected via a virtual menu (21). A start date (Prediction start date) is typed into a field (22), which defines the start of the period of time for which a recommendation is to be made as to the use of the crop protection product. The user interface can be executed in such a way that a mouseclick in the field (22) opens a virtual calendar in which the start date can be selected by mouseclick.

The Planting depth of the crop plant is set by means of a virtual slide rule (23). The planned Dosage Rate of the crop protection product is set by means of a virtual slide rule (24). The computer program can be configured such that it compares the selected dosage rate with recommended dosage rates for the selected crop protection product that may be stored in a database. If the selected dosage rate is within the range recommended for the selected crop protection product, this is indicated by a message (25). The user concludes the input of the agricultural information by pressing the virtual button (26). The effect of the pressing is that the input data are transferred to a working memory of the system of the invention/device of the invention.

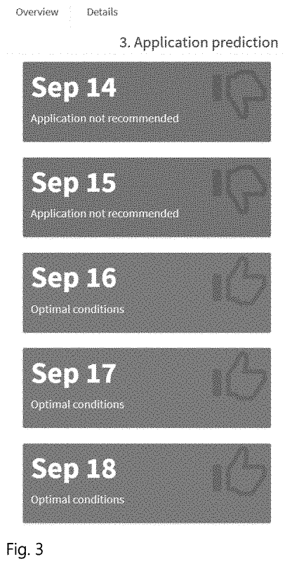

FIG. 3 shows, by way of example, a result of an analysis by the method of the invention. Use of the selected crop protection product on September 14 and 15 is not recommended. According to the analysis result, optimal conditions exist for the use of the selected crop protection product on September 16, 17 and 18.

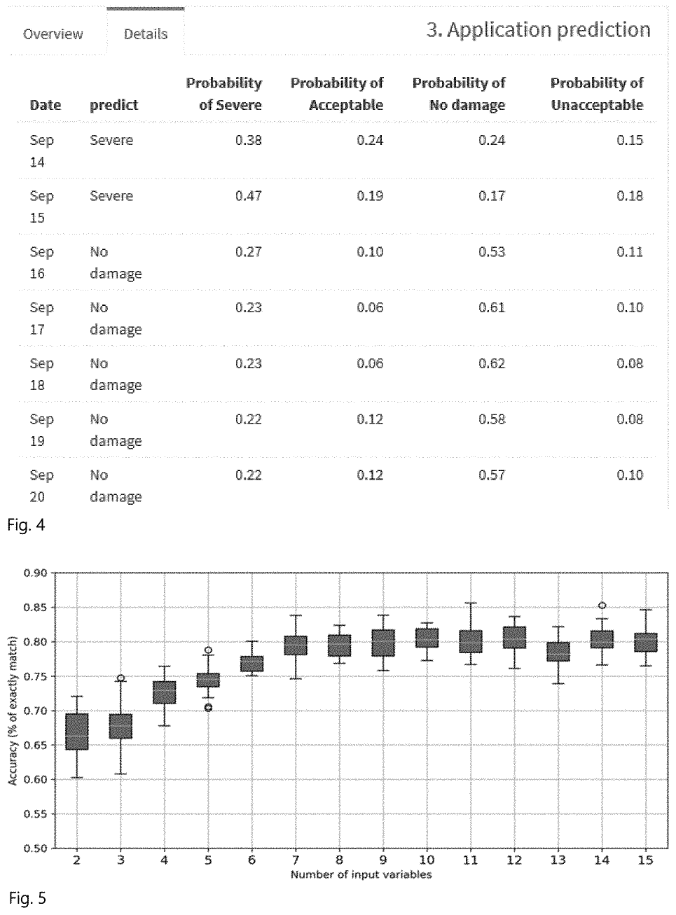

FIG. 4 shows, by way of example, a more detailed result of an analysis by the method of the invention.

FIG. 5 shows, in a graph illustration, the dependence of the forecast accuracy on the number of the most influential variables used in a classification model.

For an aclonifen-containing crop protection product, forecast models for phytotoxic action against winter wheat and winter barley have been created.

Firstly, 10 different classification models were produced from the detected variables and trial/laboratory data variables (126 in total). Subsequently, their forecast accuracy was determined. In the next step, a correlation matrix of all 126 variables was generated in order to conduct a dimension reduction thereafter. By the dimension reduction, the most influential variables were determined and the classification models were generated again. The classification model with the best forecast accuracy was selected (random forest model) and generated once again with a different number of variables, with analysis of the forecast accuracy. This can be seen in FIG. 5. In the last step, the number of variables having the highest forecast accuracy was selected. Alternatively, what is selected is not the number of input variables with which the best forecast accuracy is established, but rather the smallest number of input variables with which the forecast accuracy is negligibly below the best forecast accuracy.

As apparent in FIG. 5, the average forecast accuracy of the classification model selected is 80%. Conversely, this means an inaccuracy of 20%, which means that the classification model is wrong in 20% of cases.

However, the output data from the classification model were divided into four output classes. The output class “no damage” is defined in that no damage to the plants occurs as a side effect. The output class “acceptable damage” is defined in that very minor or just acceptable damage to the plants occurs as a side effect. The output class “unacceptable damage” is defined in that usually no longer acceptable and unacceptable damage to the plants occurs.

The output class “severe damage” is defined in that the plants are damaged completely as a side effect.

In this respect, particularly errors in the classification model that calculate acceptable damage rather than unacceptable damage and vice versa are critical. Errors in the classification model that calculate the output class “acceptable damage” rather than the output class “no damage”, for example, do not lead to a misjudgment in practice since the same positive viability of the application of the crop protection agent in the field over the period of time is ascertained.

If the rate of such errors without practical effect is 15%, for example, it is possible to assume an effective forecast accuracy of the classification model of 95% rather than 80%.

Table 1 shows which of the variables (predictors) examined in the present example permit the most accurate forecast with regard to the occurrence of phytotoxic side effects.

TABLE 1
Variables with an influence on the phytotoxic action of
aclonifen with respect to winter wheat and winter barley

| Variable | Period | Layer | Unit |
|---|---|---|---|
| Crop plant | — | — | — |
| Dosage rate of the active ingredient(s) | — | — | g/L |
| Average soil temperature (arithm. | −3 days-0 | 0-10 cm | ° C. |
| ave.) | | | |
| Cation exchange capacity | | 5-15 cm | cmol/kg |
| Cumulated precipitation | 0-3 days | — | mm |
| Plant depth | — | — | cm |
| Bulk density | — | 5-15 cm | kg kg⁻¹ |
| Minimum air temperature | 0-3 days | — | ° C. |
| Longwave radiation | −3 days-0 | — | W m⁻² |

1. A method of planning an application of a crop protection product in a field over a period of time, comprising the steps of
specifying the geographic location of the field,
providing agricultural information for the field,
providing environmental information for the field,
determining a probability of the occurrence of side effects of the crop protection product for the period of time on the basis of the agricultural information and the environmental information,
generating a conclusion as to the viability of applying the crop protection product in the field over the period of time,
communicating the conclusion to a user,
wherein one or more steps are executed by one computer or multiple computers and wherein the agricultural information is one or more pieces of information from the following list:
crop plant which is being or is to be grown in the field,
date of sowing or planting,
state of development of the crop plant being grown,
plant depth and/or seed laying depth.

2. The method according to claim 1, wherein the crop protection product comprises a herbicide, preferably a diphenyl ether herbicide, more preferably a 2-chloro-6-nitro-3-phenoxyaniline.

3. The method according to claim 1, wherein the environmental information is one or more pieces of information from the following list:
physical properties of the soil,
chemical properties of the soil,
biological properties of the soil.

4. The method according to claim 1, wherein the environmental conditions are forecast weather data for the period of time for which the use of the crop protection product is planned and forecast weather data for one or more, preferably 1, 2, 3, 4, 5 or 6, days before this period and forecast weather data for one or more, preferably 1, 2, 3, 4, 5 or 6, days after this period.

5. The method according to claim 1, wherein the crop plant being grown is a cereal, preferably winter wheat or winter barley.

6. The method according to claim 1, wherein the conclusion as to viability is the result of an ecological assessment.

7. The method according to claim 1, wherein an application is assessed as being viable if the probability of the occurrence of side effects is above a defined threshold.

8. The method according to claim 1, further comprising the step of: applying the crop protection product if application is considered viable.

9. The method according to claim 1, wherein the steps of determining a probability of the occurrence of side effects of the crop protection product for the period of time on the basis of the agricultural information and the environmental information, generating a conclusion as to the viability of applying the crop protection product in the field over the period of time, and
communicating the conclusion to a user
are effected in an automated manner by a computer system that uses the information provided in the steps of
providing agricultural information for the field, and
providing environmental information for the field,
as input parameters for the determining of the probability and for the occurrence of side effects and for the generating of the conclusion as to viability.

10. A device for planning an application of a crop protection product in a field over a period of time, comprising
an input unit,
a transmitting unit,
a receiving unit,
a processing unit, and
an output unit,
wherein the input unit is configured to enable a user of the device to specify the geographic location of the field and provide agricultural information for the field;
wherein the transmitting unit is configured to transmit geographic location information for the field and information as to the period of time;
wherein the receiving unit is configured to receive environmental information for the field for the period of time;
wherein the processing unit is configured to determine a probability of the occurrence of side effects of the crop protection product for the period of time on the basis of the agricultural information and the environmental information;
wherein the processing unit is configured to generate a statement as to the viability of application of the crop protection product in the field over the period of time;
wherein the output unit is configured to communicate the conclusion to the user of the device;
wherein the agricultural information is one or more pieces of information from the following list:
crop plant which is being or is to be grown in the field,
date of sowing or planting,
state of development of the crop plant being grown,
plant depth and/or seed laying depth.

11. A computer program product comprising a data carrier on which there is stored a computer program which can be loaded into the working memory of a computer system and therein causes the computer system to execute the following steps:
ascertaining a geographic location of a field,
ascertaining agricultural information for the field,
ascertaining environmental information for the field,
determining a probability of the occurrence of side effects of a crop protection product for a period of time on the basis of the agricultural information and the environmental information,
generating a conclusion as to the viability of applying the crop protection product in the field over the period of time,
communicating the conclusion to a user,
wherein the agricultural information is one or more pieces of information from the following list:
crop plant which is being or is to be grown in the field,
date of sowing or planting,
state of development of the crop plant being grown,
plant depth and/or seed laying depth.

12. The computer program product according to claim 11, configured such that it generates conclusions for multiple crop protection products.

13. A system comprising
an input unit configured to enable a user to specify the geographic location of a field and provide agricultural information for the field;
means of providing environmental information for the field;
a first processing unit configured to determine a probability of the occurrence of side effects of a crop protection product for a period of time on the basis of the agricultural information and the environmental information;
a second processing unit configured to generate a statement as to the viability of application of the crop protection product in the field over the period of time;
an output unit configured to communicate the conclusion to the user,
wherein the agricultural information is one or more pieces of information from the following list:
crop plant which is being or is to be grown in the field,
date of sowing or planting,
state of development of the crop plant being grown,
plant depth and/or seed laying depth.
